(19) United States
(12) Patent Application Publication
(10) Pub. No.: US 2020/0391974 A1
(43) Pub. Date: Dec. 17, 2020

(54) SHEET FOLDING APPARATUS

(71) Applicant: Shinnosuke ENOMOTO, Yamanashi-ken (JP)

(72) Inventor: Shinnosuke ENOMOTO, Yamanashi-ken (JP)

(73) Assignee: CANON FINETECH NISCA INC., Misato-shi (JP)

(21) Appl. No.: 16/887,111

(22) Filed: May 29, 2020

(30) Foreign Application Priority Data
Jun. 3, 2019 (JP) 2019-103661

(51) Int. Cl. B65H 45/16; B65H 45/18; G03G 15/00

(52) U.S. Cl. CPC B65H 45/167; B65H 45/165; G03G 2215/00877; B65H 45/18; G03G 15/6582; B65H 45/168

(57) ABSTRACT

A sheet folding apparatus folds two portions of a first folding position of a sheet and a second folding position existing between one end of the sheet and the first folding position to perform Z-fold on the sheet. Then, in a state in which a one-end side portion of the sheet and a folded portion folded in the first folding position are overlapped with each other, the apparatus adjusts a distance between one end of the sheet and the first folding position.

### BACKGROUND OF THE INVENTION

### 1. Field of the Invention

The present invention relates to a sheet folding apparatus for performing folding processing on sheets.

### 2. Description of Related Arts

Conventionally, in an image forming apparatus such as a copier and printer, it has been general that a sheet with an image formed is discharged without any processing, but there is the case of performing three-fold (Z-fold) and the like in filing discharged sheets or storing in a compact manner. There is a known sheet folding apparatus for performing such folding processing automatically.

For example, in Japanese Unexamined Patent Publication No. 2002-68583 is disclosed a sheet folding apparatus which forms a loop by feeding an upstream side of a sheet into a folding roller pair in a state of nipping a downstream end of the sheet, pushes the sheet into a nip position of the folding roller pair, while pushing a predetermined portion of the loop by a push plate, puts the predetermined portion of the loop on the downstream end of the sheet, while rotating the folding roller pair, and thereby performs Z-fold.

In the above-mentioned sheet folding apparatus, the sheet is fed so as to push the predetermined portion of the looped part toward the nip position from a position displaced from the nip position of the folding roller pair. Therefore, as shown in FIG. 18A, the downstream end of the sheet generates a deviation (tab) Lx downstream from a first fold F1.

### SUMMARY OF THE INVENTION

A sheet folding apparatus of the present invention is to fold two portions of a first folding position of a sheet and a second folding position existing between one end of the sheet and the first folding position to perform Z-fold on the sheet, and is configured to adjust a distance between one end of the sheet and the first folding position with respect to the sheet where the one-end side portion of the sheet and a folded portion folded in the first folding position are overlapped with each other. By this means, it is possible to make a Z-fold sheet with good appearance.

### BRIEF DESCRIPTION OF THE DRAWINGS

FIG. 1 is a schematic configuration view of an entire image forming apparatus system provided with a sheet folding apparatus of the present invention;

FIG. 2 is a cross-sectional view illustrating a principal configuration of the sheet folding apparatus;

FIG. 3 is a cross-sectional view of a fold-enhancing device;

FIGS. 4A and 4B contain explanatory views illustrating operation of the fold-enhancing device;

FIG. 5 is a perspective view illustrating a drive mechanism of the sheet folding apparatus;

FIG. 6 is a block diagram illustrating control of the sheet folding apparatus;

FIG. 7 is a main control flow diagram of the sheet folding apparatus;

FIGS. 8A to 8D contain explanatory views illustrating operation of Z-fold;

FIGS. 8E to 8G contain explanatory views illustrating operation of Z-fold;

FIG. 9 is a timing chart of the sheet folding apparatus;

FIG. 10 is an entire flow diagram of folding processing;

FIG. 11 is a flow diagram of alignment processing;

FIGS. 12A to 12C contain explanatory views illustrating operation of the alignment processing;

FIGS. 12D and 12E contain explanatory views illustrating operation of the alignment processing;

FIG. 13 is a flow diagram of fold-enhancing processing on a first fold;

FIG. 14 is a flow diagram of fold-enhancing processing on a second fold;

FIG. 15 is a flow diagram of another alignment processing;

FIGS. 16A to 16C contain explanatory views illustrating operation of another alignment processing;

FIGS. 17A and 17B contain cross-sectional views of a nip pressure adjusting mechanism of a folding roller pair; and

FIGS. 18A and 18B contain cross-sectional views of a three-folded sheet.

### DETAILED DESCRIPTION OF THE PREFERRED EMBODIMENT

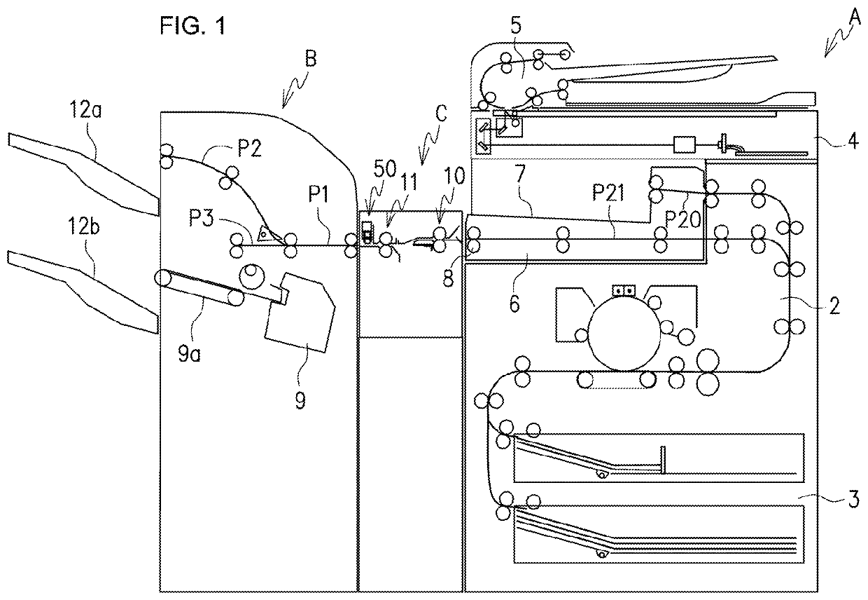

As shown in FIG. 1, a sheet folding apparatus (folding apparatus) C of the present invention is disposed between an image forming apparatus A and a post-processing apparatus (binding apparatus) B, performs various types of folding processing on sheets transported from the image forming apparatus A, and then, feeds to the binding apparatus B. In this Embodiment, a copier is used as the image forming apparatus A, the folding apparatus C is coupled to a sheet discharge opening of the copier, and on the downstream side thereof, the binding apparatus B is coupled.

The image forming apparatus A reads an original document, fed by a document feeding section 5, in an image reading section 4, and forms the read image on a sheet, fed from a paper feed section 3, in an image forming section 2. A relay transport unit 6 is attached to an in-body portion of the image forming apparatus A. In the case of not performing folding processing or binding processing on a sheet, the sheet is transported to a sheet discharge tray 7 from a first relay path P20. On the other hand, in the case of performing the folding processing or binding processing on a sheet, the sheet is fed to the folding apparatus C from a discharge roller pair 8 via a second relay path P21.

The binding apparatus B discharges the sheet to a binding processing tray 9a from a first path P1 via a third path P3, and performs staple binding in a corner or two portions of one side of the sheet on the binding processing tray 9a to discharge to a second sheet discharge tray 12b. In the case of not performing staple binding processing, the sheet fed from the folding apparatus C is discharged to a first sheet discharge tray 12a via the first path P1 and second path P2 without any processing.

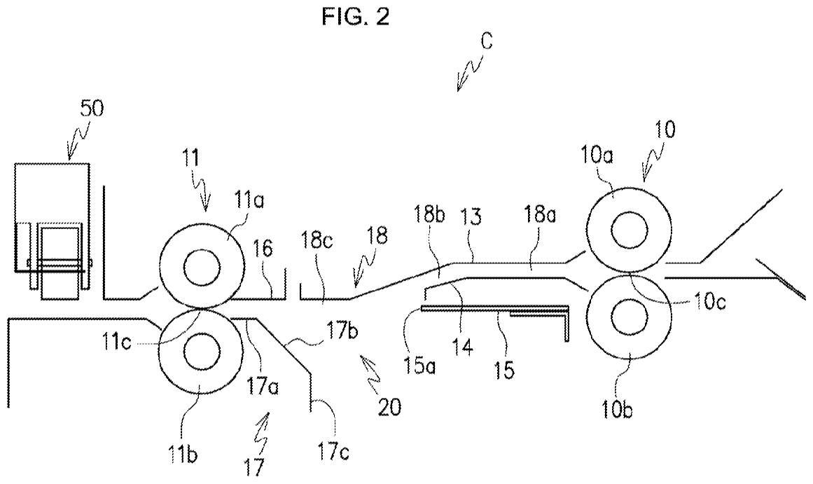

FIG. 2 illustrates a principal configuration of the folding apparatus C. The folding apparatus C is provided with a feed roller pair 10 for receiving a sheet discharged from the discharge roller pair 8 of the image forming apparatus A shown in FIG. 1, a folding roller pair 11 provided on the downstream side of the feed roller pair 10 to perform the folding processing on the sheet, a loop forming space portion 20 provided between the feed roller pair 10 and the folding roller pair 11, a push plate (push member) 15 for guiding a predetermined fold provided in the sheet toward a nip portion 11c of folding roller pair 11, and a transport path 18 for guiding the sheet toward the folding roller pair 11 from the feed roller pair 10. Folding operation of the sheet is halted in a state in which a downstream end side of the sheet in a sheet transport direction is first nipped by the nip portion 11c of the folding roller pair 11. In this state, by feeding the sheet from the feed roller pair 10, a loop portion with a predetermined length is formed in the loop forming space portion 20. Then, a first folding position of the loop portion set at the first fold is guided to the nip portion 11c by the push plate 15, and the folding roller pair 11 is rotated in the transport direction. By this means, three-fold (Z-fold) processing is performed to provide the sheet with the first fold and a second fold formed on the upstream side of the first fold.

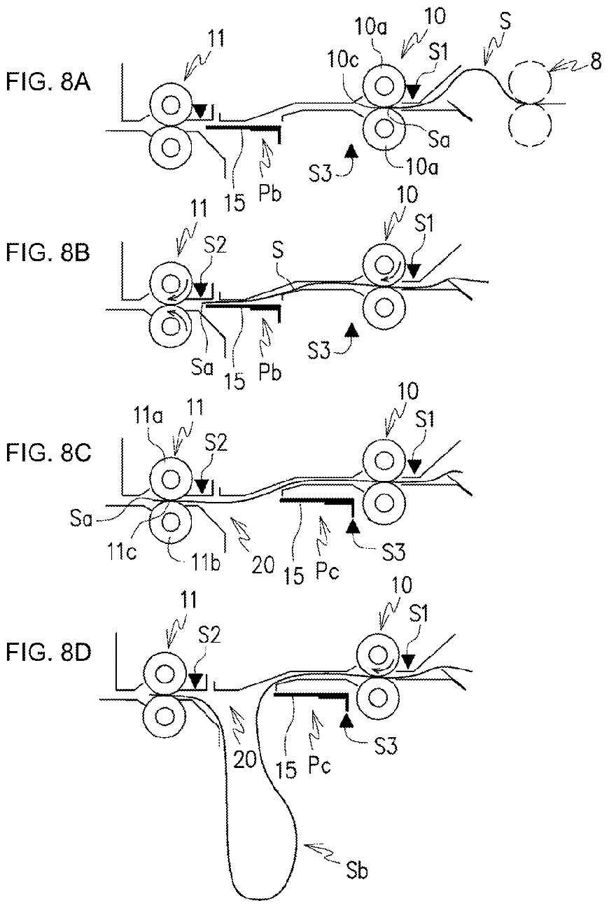

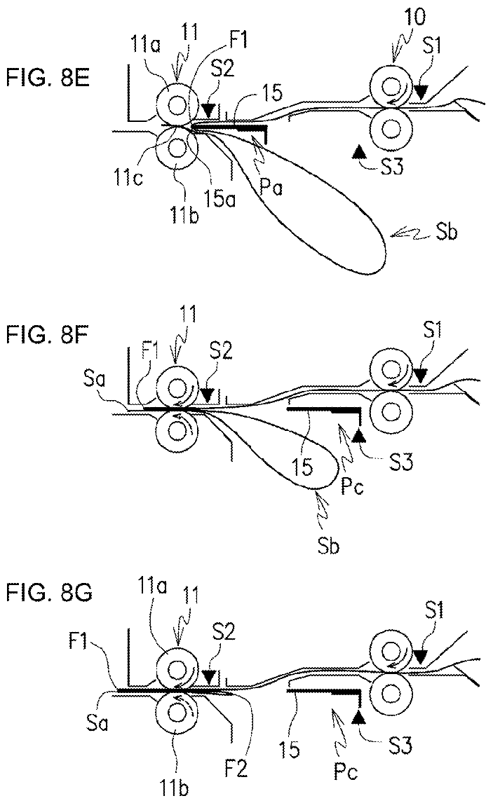

The feed roller pair 10 is comprised of a feed upper roller 10a which rotates by motor drive, and a feed lower roller 10b which is driven by rotation of the feed upper roller 10a to rotate. As shown in FIGS. 8A and 8B, the feed roller pair 10 is in a state of halting until a sheet S arrives, and in this state, a downstream end Sa of the sheet S fed from upstream strikes the nip portion 10c. By this means, the sheet S is aligned, and by the feed roller pair 10 rotating in this state, the sheet S is transported to the folding roller pair 11.

The transport path 18 is comprised of a first transport path 18a extending in a horizontal direction from the nip portion 10c of the feed roller pair 10, a second transport path 18b extending, while being inclined downward from the downstream side of the first transport path 18a, and a third transport path 18c extending in the horizontal direction from the downstream side of the second transport path 18b to reach the folding roller pair 11. The first transport path 18a and second transport path 18b are provided with a feed upper guide 13, feed lower guide 14 and push plate 15. The third transport path 18c is formed of a folding upper guide 16 and folding lower guide 17. Further, the folding lower guide 17 is formed of a horizontal guide portion 17a extending in the horizontal direction, an inclined guide portion 17b being inclined, and a vertical guide portion 17c provided to extend in a vertical direction.

The folding roller pair 11 is comprised of a folding upper roller 11a and folding lower roller 11b, and is disposed lower than an extension line extended in the horizontal direction from the nip portion 10c of the feed roller pair 10. In other words, the folding roller pair 11 and feed roller pair 10 are disposed in a state of being displaced slightly in the vertical direction. As shown in FIGS. 8A to 8G, the folding roller pair 11 halts in a state of nipping the downstream side of the sheet S transported from the feed roller pair 10, and forms a loop portion Sb with a predetermined length on the upstream side of the nipped position. Then, by transporting in a state of nipping so that the downstream side overlaps a first fold F1 obtained by pushing a first folding position of the loop portion Sb by the push plate 15, the sheet S is subjected to Z-fold.

The push plate 15 is a plate-shaped member provided to extend in a sheet width direction, and is disposed below the feed lower guide 14. The push plate 15 is configured to slide and shift among a push position Pa where a front end portion 15a thereof enters between the folding upper guide 16 and the folding lower guide 17 to guide the first fold F1 of the sheet S toward the nip portion 11c of the folding roller pair 11 as shown in FIG. 8E, a guide position Pb opposed to the downstream side of the feed upper guide 13 to form a part of the third transport path 18c as shown in FIGS. 8A and 8B, and a retract position Pc retracted from the push position Pa to the upstream side to release the loop forming space portion 20 as shown in FIGS. 8C and 8D and FIGS. 8F and 8G.

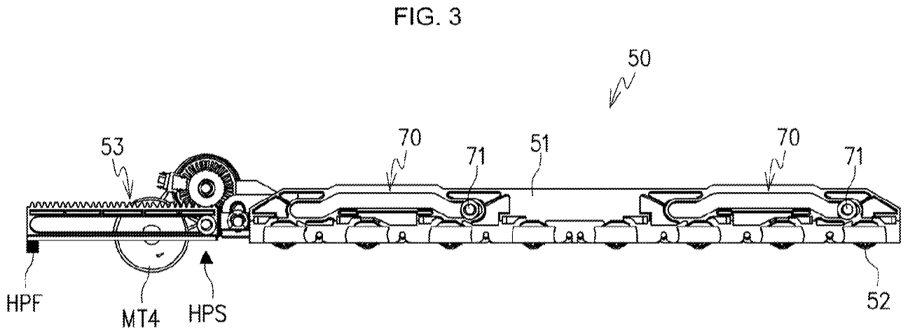

On the downstream side of the folding roller pair 11 is disposed a fold-enhancing portion (fold-enhancing device) 50. As shown in FIG. 3, the fold-enhancing device 50 is comprised of a fold-enhancing unit 51 having a plurality of rollers 52 provided to be able to rotate in a width direction of a sheet orthogonal to the transport direction of the sheet, a shift mechanism 53 for shifting the fold-enhancing unit 51 in the vertical direction and the width direction of the sheet, and a fold-enhancing motor MT4 for operating the shift mechanism 53. The shift mechanism 53 is provided with an operation pin 71 provided in a main body of the folding apparatus C, a cam 70 provided in the fold-enhancing unit 51 to engage in the operation pin 71 to guide the fold-enhancing unit 51 in the vertical direction and the width direction of the sheet, and a home position flag HPF and home position sensor HPS for detecting a home position in the cam 70.

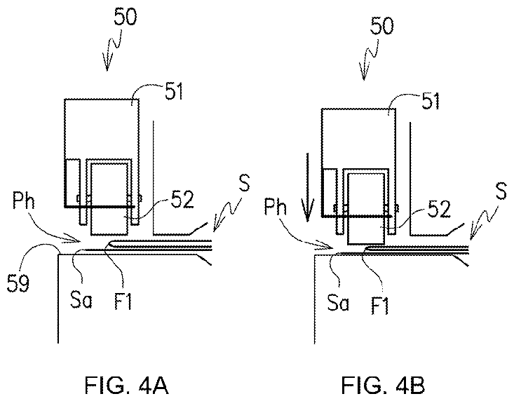

As shown in FIGS. 4A and 4B, the above-mentioned fold-enhancing device 50 nips, with a plurality of rollers 52, the first fold F1 of the sheet S transported onto a pressing bench 59 by the folding roller pair 11 to press, and is thereby capable of aligning the first fold F1 of the sheet S flat. First, when the first fold Fl of the sheet S transported toward the fold-enhancing device 50 arrives at a fold-enhancing position Ph (FIG. 4A), the fold-enhancing unit 51 is shifted downward, and presses the first fold F1 of the sheet S with the plurality of rollers 52 (FIG. 4B). Then, by shifting the fold-enhancing unit 51 in the sheet width direction, the plurality of rollers 52 shifts on the first fold F1, while rotating, and thereby presses the entire first fold F1. On the other hand, a second fold F2 (not shown in the figure) formed on the upstream side of the first fold F1 is similarly pressed.

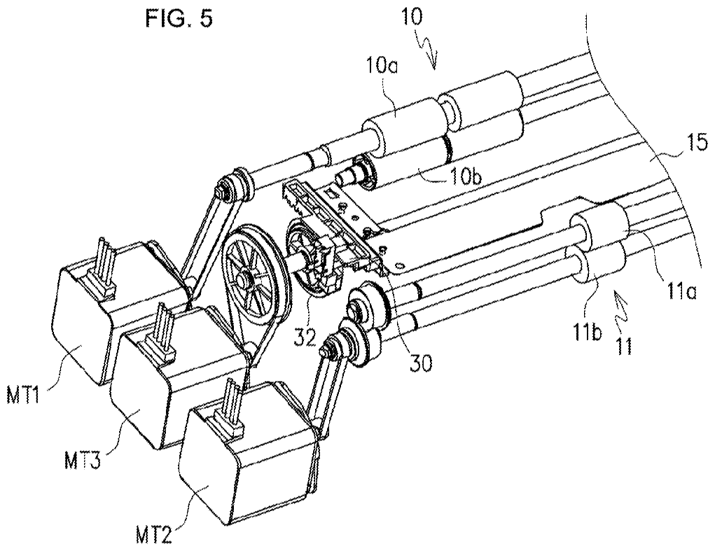

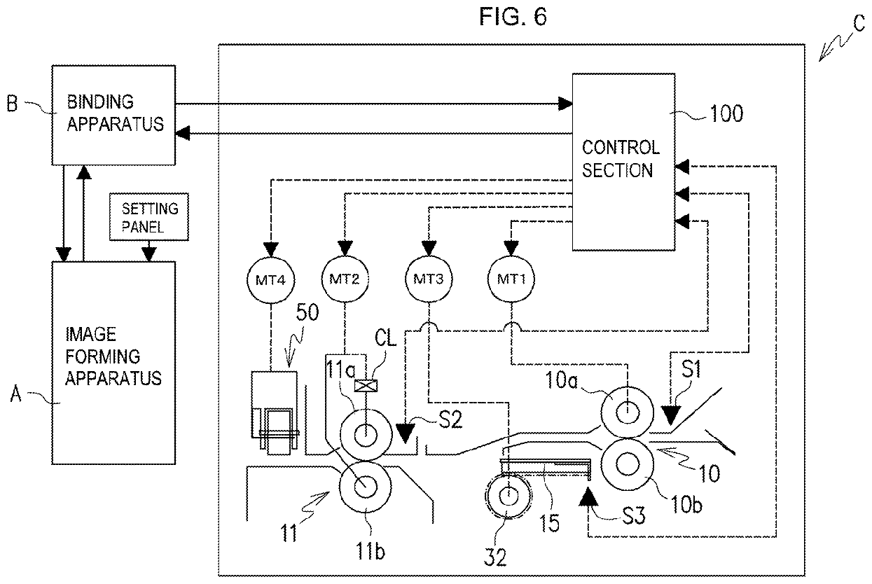

FIG. 5 illustrates a configuration of a drive system in the folding apparatus C. In the feed roller pair 10, the feed upper roller 10a is coupled to the feed motor MT1 via a transfer mechanism (not shown in the figure), and the feed lower roller 10b is driven by the feed upper roller 10a to rotate. Next, a drive section to drive the folding roller pair 11 is provided with a folding motor MT2, a drive transfer mechanism of the folding motor MT2, and an electromagnetic clutch CL of the folding upper roller 11a. Then, the folding upper roller 11a and folding lower roller 11b of the folding roller pair 11 are coupled to the folding motor MT2 to be driven via a transfer mechanism comprised of a gear, pulley and timing belt. Then, by forward-rotation drive of the folding motor MT2, the folding upper roller 11a and folding lower roller 11b rotate in the sheet transport direction, and cooperate to transport the sheet downstream in the transport direction. In addition, as shown in FIG. 6, the folding upper roller 11a is coupled and driven via the electromagnetic clutch CL, and by controlling the electromagnetic clutch CL, forward-rotation drive of the folding motor MT2 is transferred to the folding upper roller 11a, while the folding motor MT2 does not transfer backward-rotation drive to the folding upper roller 11a. A drive mechanism of the push plate 15 is provided with a rack 30 for holding a push motor MT3 and opposite ends of the push plate 15, and a pinion 32 meshing with the rack 30. Drive of the push motor MT3 is transferred to the pinion to rotate, and first and second racks 30, 31 are thereby synchronized to shift. By this means, the push plate 15 reciprocates and shifts in the horizontal direction.

FIG. 6 illustrates a configuration of a control system for controlling the folding apparatus C. The folding apparatus C is provided with a plurality of sensors, and by the plurality of sensors, a position of a sheet is detected. The plurality of sensors is comprised of an entrance sensor S1 for detecting the downstream end of the sheet, on the upstream side of the feed roller pair 10, a folding sensor S2 disposed on the upstream side of the folding roller pair 11 to detect the downstream end of the sheet undergoing folding processing, and a push sensor S3 for detecting a shift position of the push plate 15. These sensors are controlled by a control section 100. The control section 100 receives information on a type of sheets, folding mode and the like set with an operation panel provided in the image forming apparatus A via the binding apparatus B.

Then, based on various kinds of information from the image forming apparatus A and detection results of the sheet by each of the sensors S1, S2 and S3, drive of each of the motors MT1, MT2, MT3 and MT4 is controlled to execute transport of the sheet and folding operation. Further, the control section 100 is provided with functions of transmitting information such as transport status of the sheet and the like to the image forming apparatus A via the binding apparatus B, and reporting a transport failure and the like by the folding apparatus C to a user.

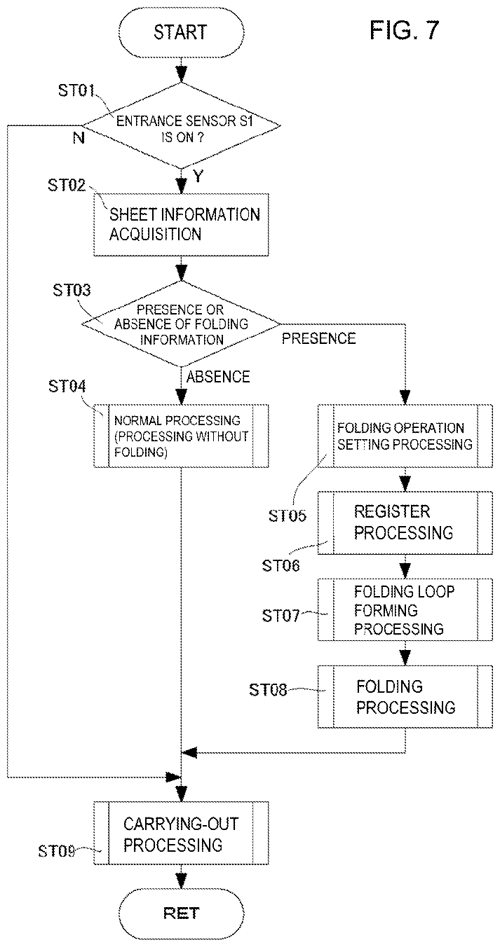

FIG. 7 illustrates a main control flow of the folding apparatus C. The folding apparatus C of this Embodiment is provided with a mode “with folding” for performing Z-fold on a sheet, and a mode “without folding” for not performing folding processing. First, using detection of the downstream end of the sheet by the entrance sensor S1, as a trigger, the folding apparatus C acquires sheet information on the size, material, paper thickness and the like of the sheet and post-processing information on the folding mode and the like from the image forming apparatus A via the binding apparatus B (ST01, ST02). When the acquired information includes information indicative of “with folding” (ST03), the apparatus C executes folding operation setting processing (ST05) for setting various values such as a folding loop counter value to fold a sheet (ST05), and aligns the downstream end of the sheet in register processing (ST06) to correct sheet skew. Then, a loop portion is formed in the sheet in folding loop forming processing (ST07). The loop portion is pushed by the push plate 15 in folding processing (ST08) to be nipped by the folding roller pair 11. In the sheet thus subjected to the folding processing, the fold of the sheet is further pressed by fold-enhancing processing described later, and the sheet is carried out to the binding apparatus B on the downstream side in a state in which a bulge of the fold is flattened (ST09).

On the other hand, when the acquired information does not include the information for designating “with folding” (ST03), normal processing (processing without folding) is executed (ST04). The normal processing is to drive the feed roller pair 10 and folding roller pair 11 in a state in which the push plate 15 is shifted to the guide position Pb (see FIGS. 8A and 8B) for forming a part of the third transport path 13c, and to carry out to the binding apparatus B without performing the folding processing on the sheet received in the folding apparatus C (ST09).

FIGS. 8A to 8G illustrate a series of movement of the sheet S to form Z-fold. First, the downstream end Sa of the sheet S discharged via the discharge roller pair 8 of the image forming apparatus A is detected by the entrance sensor S1, and is thereby nipped to enable the sheet to be transported by the feed roller pair 10 (see FIG. 8A).

The sheet S nipped by the feed roller pair 10 is transported downstream by the feed roller pair 10 along the folding upper guide 16, folding lower guide 17 and push plate 15 (see FIG. 8B).

Then, when the folding sensor S2 detects the downstream end Sa of the sheet S, after feeding out to the downstream side by a predetermine amount in association with rotation of the folding roller pair 11, rotation of the folding roller pair 11 is once halted. By halting the folding roller pair 11, after holding the downstream side of the sheet S by a nip of the folding roller pair 11, the push plate 15 is shifted to the retract position Pc on the upstream side (see FIG. 8C).

By the shift of the push plate 15, the loop forming space portion 20 is formed below between the folding upper guide 16 and folding lower guide 17. During this period, by continuing to rotate the feed roller pair 10, the loop portion Sb is formed in the sheet S (see FIG. 8D).

When the predetermined loop portion Sb is formed in the sheet S, the push plate 15 is shifted to the push position Pa on the downstream side, and is halted before the folding roller pair 11 (see FIG. 8E).

Then, when the folding roller pair 11 is driven to rotate again, the first folding position of the sheet S is nipped by the folding roller pair 11. By this means, the sheet is folded in the first folding position, the first fold F1 is formed in the first folding position, and first folding is performed on the sheet S (see FIG. 8F).

After forming the first fold F1 in the sheet S by the folding roller pair 11 and performing first folding, the folding roller pair 11 is rotated in the transport direction continuously. By rotation of the folding roller pair 11, when the sheet S is fed out toward the downstream side, the loop portion Sb is gradually narrowed, the sheet is eventually narrowed and folded by the folding roller pair 11, the second fold F2 is formed in the second folding position, and second folding is performed (see FIG. 8G).

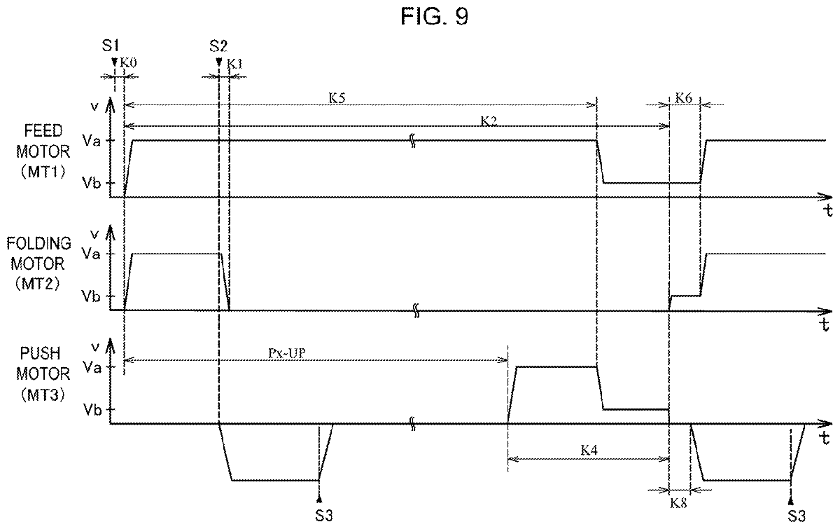

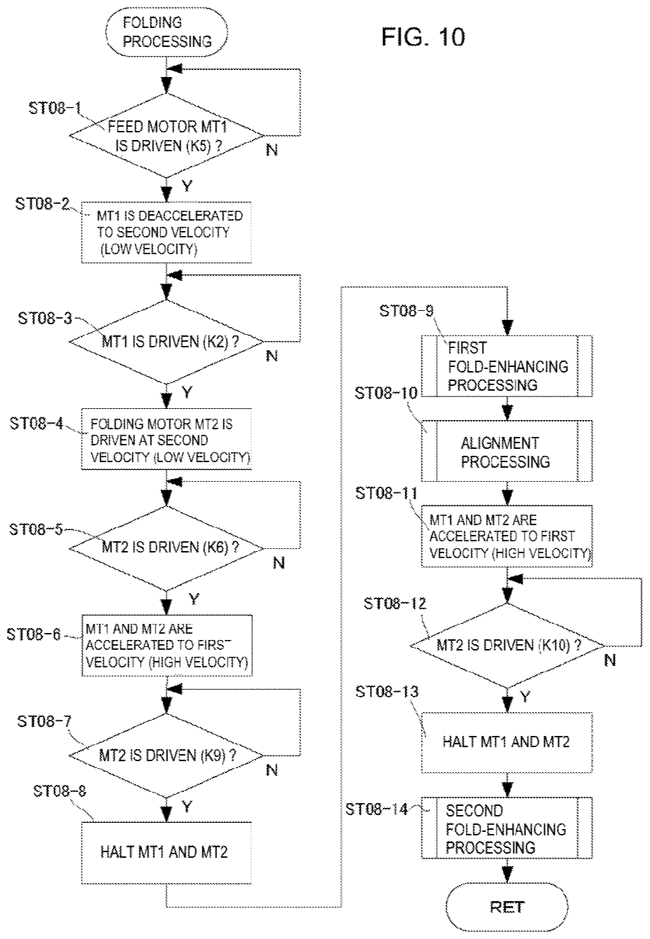

Next, details of folding operation shown in the above-mentioned FIGS. 8A to 8G will be described based on FIGS. 9 and 10. As shown in FIGS. 8A and 8B, during continuation of sheet feeding by the feed roller pair 10, a loop counter value (Px-UP) for counting time taken to form the loop portion Sb is counted up, and push processing is started. In addition, although there is no description in the main flow control of FIG. 7, the push processing for shifting the push plate 15 to the push position Pa and retract processing for shifting the push plate 15 to the retract position Pc is executed concurrently with the folding loop forming processing and folding processing. In the push processing, the push plate 15 is shifted in the sheet feed direction. A shift velocity of the push plate 15 at this point is controlled to be the same velocity as a shift velocity of the sheet fed by the feed roller pair 10. In the folding processing, when the feed motor MT1 reaches a fifth set amount (K5) (FIG. 9), the feed motor MT1 is deaccelerated from a high first velocity Va to a low second velocity Vb (FIG. 10 (ST08-1˜ST08-2)). Concurrently, also in the push processing, the push motor MT3 is deaccelerated. By this means, the shift velocities of the sheet and push plate 15 are concurrently deaccelerated from the high velocity to the low velocity.

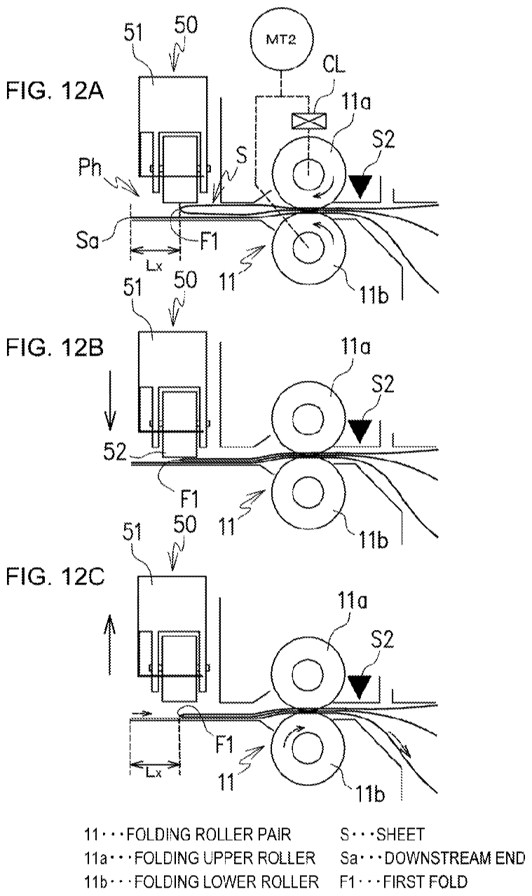

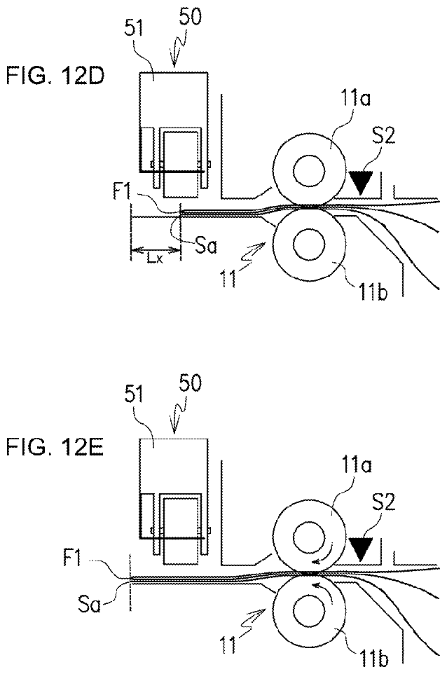

Next, at the time of driving a second set amount (K2) after driving the feed motor MT1 (FIG. 9), drive of the folding motor MT2 is started at a second velocity (ST08-3˜ST08-4). At this point, as shown in FIG. 8E, the push plate 15 is shifted to the push position Pa. Then, the first folding position of the sheet positioned in a position facing the nip portion 11c of the folding roller pair 11 by the push plate 15 is nipped by rotation of the folding roller pair 11, and by folding back, the first fold F1 is formed. Further, in folding the sheet by the folding roller pair 11, the first fold F1 is put on the downstream side (front end portion) Sa1 of the sheet in the position of the nip portion 11c. In this Embodiment, as shown in FIGS. 12A to 12E, by driving the folding motor MT2 at the second velocity, control is performed so as to suppress to minimize a protrusion amount (tab amount) Lx of the downstream end Sa of the sheet A with respect to the first fold F1.

At the time of driving a sixth set amount (K6) from the time of starting driving of the folding motor MT2 (FIG. 9), the feed motor MT1 and folding motor MT2 are accelerated to first velocities (ST08-5˜ST08-6). At this point, as shown in FIG. 8F, the first fold F1 of the sheet passes through the folding roller pair 11. In addition, the sixth set amount (K6) is a drive amount required for the first folding position of the sheet to be reliably nipped and folded by the folding roller pair 11. Subsequently, at the time of driving a ninth set amount (K9) from starting driving of the folding motor MT2, the feed motor MT1 and folding motor MT2 are halted (ST08-7˜ST08-8). By this means, the first fold F1 is fed to a fold-enhancing position Ph, and is positioned in the fold-enhancing position Ph (FIG. 12A). In other words, the ninth set amount (K9) is a drive amount of the folding motor MT2 that corresponds to a distance from the nip portion 11c of the folding roller pair 11 to the fold-enhancing position Ph. When the first fold F1 is fed to the fold-enhancing position Ph, first fold-enhancing processing is executed to press the first fold F1 (ST08-9) (FIG. 12B). In the first fold-enhancing processing, the first fold F1 is subjected to fold-enhancing by the fold-enhancing device 50, and subsequently, alignment processing is executed (ST08-10).

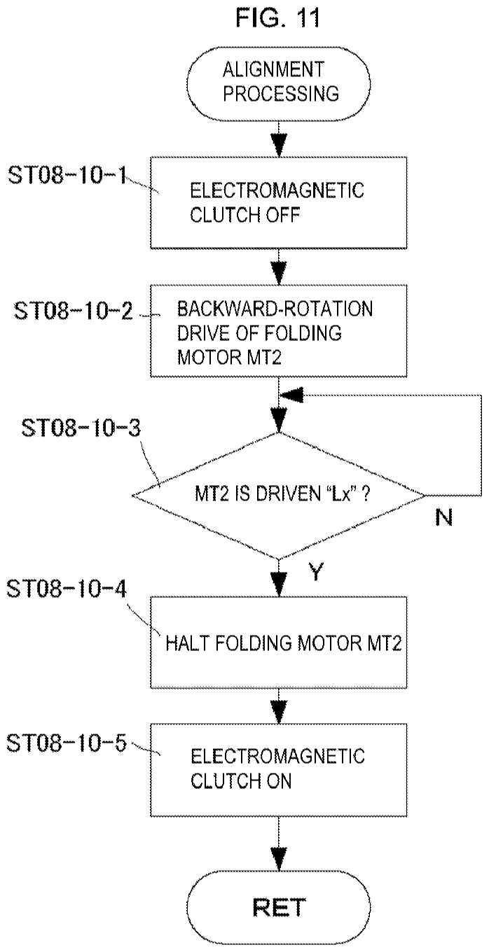

FIG. 11 illustrates details of the alignment processing. In the alignment processing (ST08-10), the folding roller pair 11 is controlled so as to adjust positions of the downstream end (front end) Sa of the sheet and first fold F1 (first folding position) to match. In other words, the folding roller pair 11 also has the function of adjusting the positions of the downstream end (front end) Sa of the sheet and first fold F1 (first folding position). Then, an adjustment section is comprised of also the folding roller pair 11 and a drive section for driving the folding roller pair 11 to adjust the positions of the downstream end Sa of the sheet and first fold F1.

The alignment processing will be described. First, OFF is set on the electromagnetic clutch to transfer drive from the folding motor MT2 to the folding upper roller 11a, and the folding motor MT2 is driven to rotate backward (ST08-10-1˜ST08-10-2). By this means, drive transfer of the folding upper roller 11a is discontinued, only the folding lower roller 11b rotates in a sheet return direction (upstream side), and in the downstream side front end portion Sa1 of the sheet and a folded portion F1a of the first fold F1 overlapping the portion Sa1, only the downstream side front end portion Sa1 of the sheet is shifted to the upstream side. In other words, the downstream end Sa of the sheet S is returned to the upstream side (FIG. 12C). Then, after driving the folding motor MT2 by the number Px of drive pulses that corresponds to the tab amount Lx, backward-rotation drive of the folding motor MT2 is halted (ST08-10-3˜ST08-10-4). By this means, the downstream end Sa of the sheet S is returned corresponding to the tab amount Lx, i.e. to the position of the first fold F1, and the adjustment is made to be a state in which the positions of the downstream end Sa of the sheet and first fold F1 are matched (FIG. 12D). Then, the electromagnetic clutch is turned ON, drive transfer is coupled from the folding motor MT2 to the folding upper roller 11a, and the alignment processing is finished (ST08-10-5). In addition, in feeding the sheet from the feed roller pair 10 to the folding roller pair 11, the tab amount Lx is the number of pulses obtained by counting the number of drive pulses up to a halt of the sheet from the time of detecting the downstream end of the sheet by the folding sensor S2, and subtracting the number of drive pulses that corresponds to the distance from the folding sensor S2 to the nip portion 11c of the folding roller pair 11 from the count value, and is beforehand set value.

After matching the downstream end Sa of the sheet and the position of the first fold F1 in the alignment processing, the feed motor MT1 and folding motor MT2 are driven at first velocities. By this means, the sheet is transported to the downstream side by the folding roller pair 11 in a state in which the downstream end Sa of the sheet and the first fold F1 overlap each other (FIG. 12E). Then, at the time of driving the folding motor MT2 by a tenth set amount (K10), the feed motor MT1 and folding motor MT2 are halted (ST08-11˜ST08-13). By this means, the second fold F2 is fed to the fold-enhancing position Ph by the feed roller pair 10 and folding roller pair 11, and is positioned therein (see FIG. 8G). Thus, when the second fold F2 is fed to the fold-enhancing position Ph and is positioned, fold-enhancing processing is executed on the second fold F2 (ST08-14).

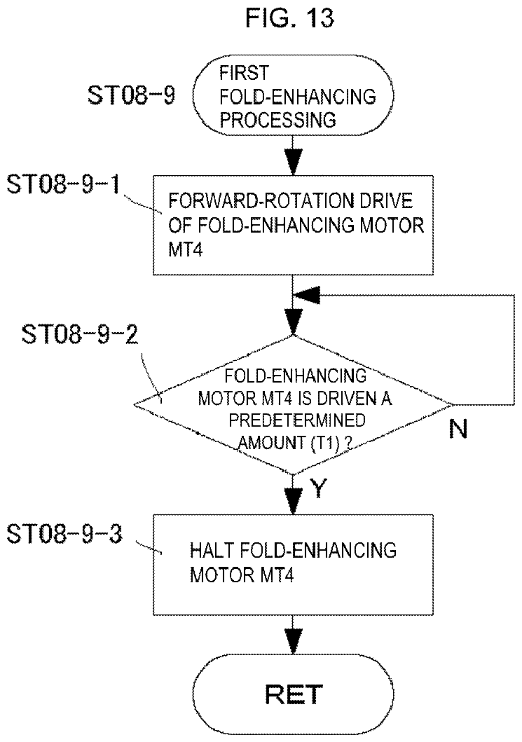

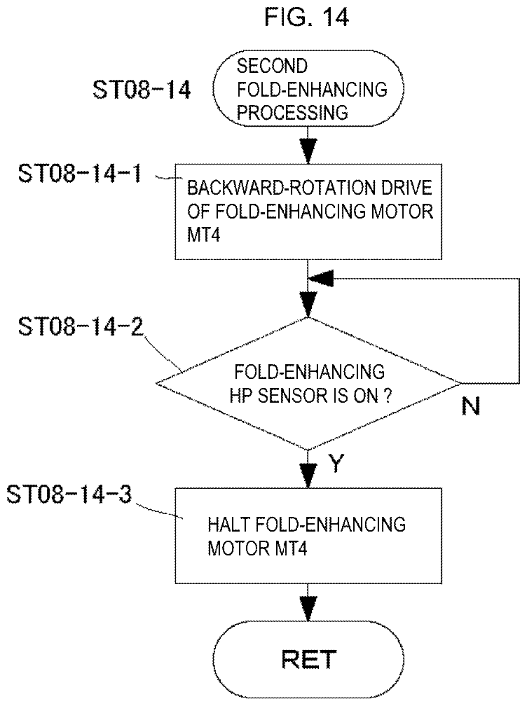

Next, the fold-enhancing processing will be described based on FIGS. 3, 13 and 14. As shown in FIG. 13, in first fold-enhancing processing (ST08-9) for pressing the first fold F1, when the first fold F1 arrives at the fold-enhancing position Ph, the fold-enhancing motor MT4 is driven to rotate forward only by a predetermined amount, and is halted (ST08-9-1˜ST08-9-3). By this means, the fold-enhancing unit 51 shifts from a home position to a waiting position. During the shift process, the fold-enhancing unit 51 moves downward along the cam 70, and the plurality of rollers 52 presses the first fold F1 to perform fold-enhancing. Subsequently, the fold-enhancing unit 51 moves upward, and the plurality of rollers 52 separates from the fold-enhanced first fold F1. In addition, the predetermined amount is an amount for moving the fold-enhancing unit 51 in the home position downward along the cam 70, and then, moving upward to shift to the waiting position. As shown in FIG. 14, in the second fold-enhancing processing (ST08-14) for pressing the second fold F2, when the second fold F2 arrives at the fold-enhancing position Ph, the fold-enhancing motor MT4 is rotated backward. Then, when the home position sensor HPS (See FIG. 3) to detect the home position is ON, the fold-enhancing motor MT4 is halted (ST08-14-1˜ST08-14-3). By this means, the fold-enhancing unit 51 shifts from the waiting position to the home position. During the shift process, the fold-enhancing unit 51 moves downward along the cam 70, and the plurality of rollers 52 presses the second fold F2 to perform fold-enhancing. Subsequently, the fold-enhancing unit 51 moves upward, and the plurality of rollers 52 separates from the fold-enhanced second fold F2. Herein, by causing the fold-enhancing unit 51 to reciprocate, the first fold F1 and second fold F2 are subjected to fold-enhancing. In other words, it is configured that in the first fold-enhancing processing, while shifting the fold-enhancing unit 51 in one direction, the first fold F1 is pressed by the plurality of rollers 52, and that in the second fold-enhancing processing, while shifting the fold-enhancing unit 51 in the other direction, the second fold F2 is pressed by the plurality of rollers 52.

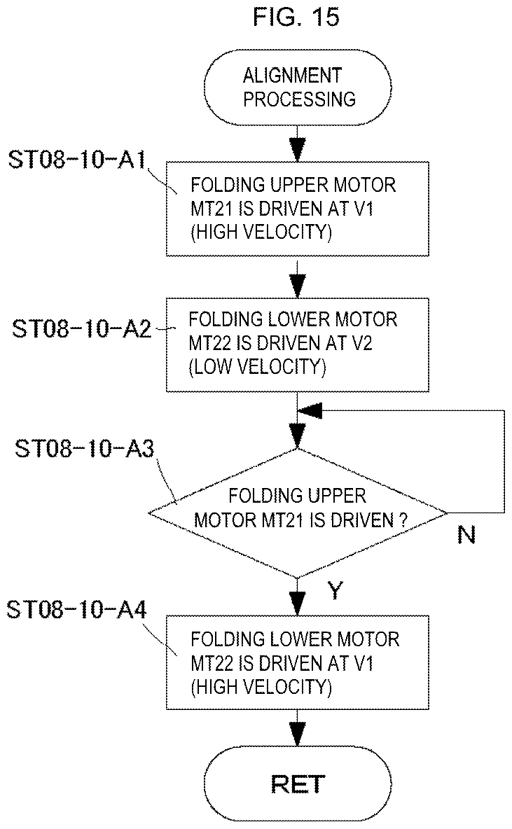

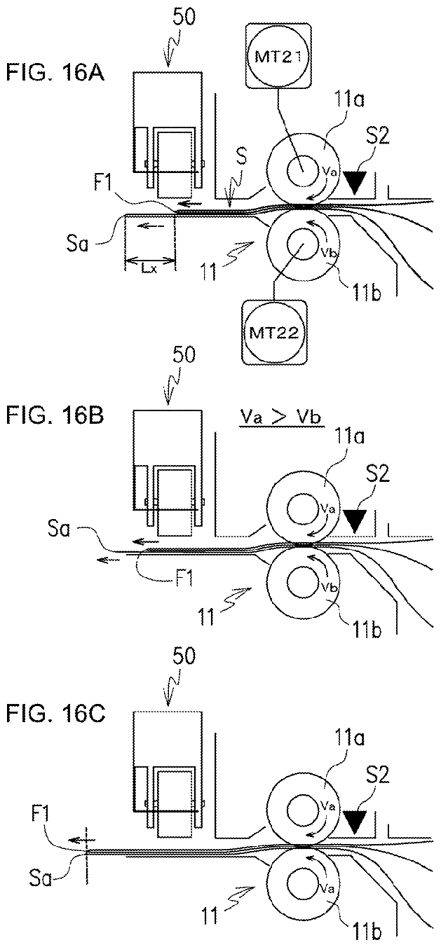

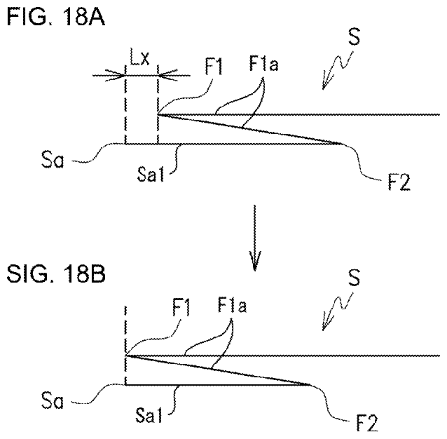

FIGS. 15 and 16A to 16C illustrate an Embodiment of another alignment processing. The alignment processing is to control so as to match the downstream end (front end) of the sheet and first fold F1 (first folding position) by a difference in rotation velocity between the folding upper roller 11a and the folding lower roller 11b. In this Embodiment, as shown in FIG. 16A, the folding upper roller 11a is coupled to a folding upper motor MT21, and the folding lower roller 11b is coupled to a folding lower motor MT22. The folding upper motor MT21 and folding lower motor MT22 are driven independently of each other. After pressing the first fold F1 of the sheet by the fold-enhancing device 50, the folding upper motor MT21 is driven at a high velocity V1. Concurrently therewith, the folding lower motor MT22 is driven at a velocity V2 slower than the velocity V1 (ST08-10-A1˜ST08-10-A2). In other words, the rotation velocity of the folding upper roller 11a is Va, and the rotation velocity of the folding lower roller 11b is Vb slower than Va. By this means, a shift velocity of the downstream side front end portion Sa1 of the sheet is slower than a shift velocity of the folded portion F1a of the first fold F1, and as shown in FIGS. 16A and 16B, a distance between the downstream end of the sheet and the first fold F1 is gradually narrowed. Then, when the folding upper motor MT21 reaches a predetermined drive amount, as shown in FIG. 18B, the downstream end Sa of the sheet S and the first fold F1 are matched with each other (FIG. 16C).

Thus, after matching the downstream end Sa of the sheet S and the first fold F1 by driving the folding upper motor MT21 by a predetermined amount, the velocity of the folding lower motor MT22 is increased to be the velocity V1 of the folding upper motor MT21 (ST08-10-A3˜ST08-10-A4). By this means, the sheet is transported downstream in a state in which the downstream end Sa of the sheet S and the first fold F1 overlap each other.

In the alignment processing, drive amounts of velocities V1 and V2 of the folding upper motor MT21 and folding lower motor MT22 are set respectively, so that the downstream end Sa of the sheet S and first fold F1 are matched with each other before nipping the second fold F2 by the folding roller pair 11.

Linear velocities Va and Vb of the folding upper roller 11a and folding lower roller 11b are expressed by relational expression of “(Vbxt)+Lx=Vaxt”. Herein, when it is assumed that Va=300 mm/s, Lx=10 mm, and that t=0.1 s, it holds that Vb=((Vaxt)−Lx)/t=((300×0.1)−10)/0.1=200 mm/s.

In addition, in a state in which the liner velocity Vb of the folding lower roller 11b is “0” i.e. the roller 11b is halted, by driving the folding upper roller 11a, control may be performed so as to match the downstream end of the sheet and first fold F1.

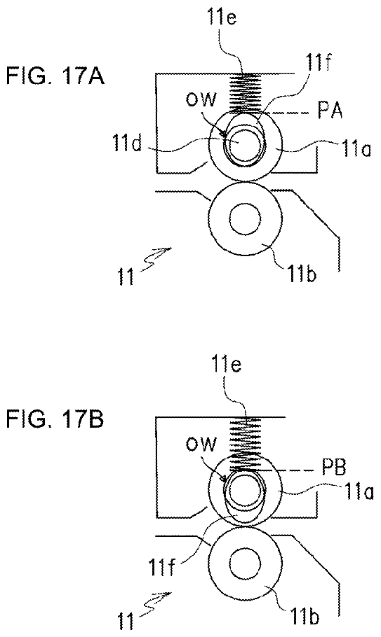

FIGS. 17A and 17B show one example of a nip pressure adjusting mechanism for reducing nip pressure of a sheet, in adjusting a position of a predetermined fold of the sheet with respect to the downstream end of the sheet in the above-mentioned alignment processing. The nip pressure adjusting mechanism is provided with an eccentric cam 11f attached to a shift 11d for rotation-supporting the folding upper roller 11a via one way clutch OW. When the motor for driving the folding upper roller 11a is driven to rotate backward to rotate the shaft 11d backward (direction of returning the sheet to the upstream side), the eccentric cam 11f rotates to expand an adjustment spring 11e for biasing the folding upper roller 11a to the folding lower roller 11b. By this means, it is possible to reduce the nip pressure imposed on the folding lower roller 11b by the folding upper roller 11a. Before executing the alignment processing, the shaft 11d is rotated backward by a predetermined amount so as to shift the adjustment spring 11e and eccentric cam 11f from a pressure increasing position PA shown in FIG. 17A to a pressure reducing position PB shown in FIG. 17B. On the other hand, after executing the alignment processing, the shaft 11d is rotated backward further by a predetermined amount so as to shift the adjustment spring 11e and eccentric cam 11f from the pressure reducing position PB shown in FIG. 17B to the pressure increasing position PA shown in FIG. 17A.

Further, in the folding upper roller 11a and folding lower roller 11b, roller faces are formed of rubber so that coefficients of friction between the sheet and the folding upper roller 11a and between the sheet and the folding lower roller 11b are higher than a coefficient of friction between overlapped sheet portions. Further, by configuring that the coefficient of friction with respect to the sheet is higher in the folding lower roller 11b than the folding upper roller 11a, it is possible to increase a sheet hold force in driving the folding lower roller 11b to rotate backward, and it is possible to reliably transport in the backward-rotation direction corresponding to a single sheet.

In addition, in each of the above-mentioned Embodiments of the alignment processing, control is performed so that the downstream end (front end) Sa of the sheet S and the first fold F1 (first folding position) are matched with each other, but slight fluctuations actually arise in the position relationship between the downstream end Sa of the sheet S and the first fold F1. However, by such control, the first fold F1 is formed in the sheet S by the folding roller pair 11, and it is possible to make a deviation (tab) amount of the downstream end of the sheet with respect to the first fold F1 smaller than at the time of performing first folding (see FIG. 8F). By this means, it is possible to prepare the sheet subjected to the folding processing with good appearance.

Further, by changing a backward-rotation drive amount of the folding motor MT2 in the alignment processing shown in FIG. 11, it is possible to flexibly adjust the position relationship between the downstream end (front end) Sa of the sheet and the first fold (first folding position) F1. For example, it is also possible to position the first fold F1 downstream from the downstream end Sa of the sheet. Also in the Embodiment of another alignment processing, as a matter of course, by changing a rotation velocity difference between the folding upper roller 11a and the folding lower roller 11b, it is possible to flexibly adjust the position relationship between the downstream end Sa of the sheet and the first fold F1.

In the foregoing, the present invention is described in association with the preferred Embodiments, but the invention is not limited to the above-mentioned Embodiments, and it is obvious that the invention is capable of being carried into practice with various changes or modifications in the technical scope thereof.

This application claims priority based on Japanese Patent Application No. 2019-103661 filed on Jun. 3, 2019, the entire content of which is expressly incorporated by reference herein.

1. A sheet folding apparatus comprising:
a folding section adapted to fold two portions of a first folding position of a sheet and a second folding position existing between one end of the sheet and the first folding position to perform Z-fold on the sheet; and
an adjustment section adapted to adjust a distance between the one end of the sheet and the first folding position with respect to the sheet where a one-end side portion of the sheet and a folded portion folded in the first folding position are overlapped with each other in the folding section.

2. The sheet folding apparatus according to claim 1, wherein the adjustment section is provided with a transport roller pair for overlapping the one-end side portion of the sheet and the folded portion folded in the first folding position to transport, and a drive section for driving the transport roller pair, and
the drive section rotates one roller in the transport roller pair in a direction opposite to a transport direction.

3. The sheet folding apparatus according to claim 1, wherein the adjustment section is provided with a transport roller pair for overlapping the one-end side portion of the sheet and the folded portion folded in the first folding position to transport, and a drive section for driving the transport roller pair, and
the drive section makes a velocity at which one roller in the transport roller pair rotates in a transport direction lower than a velocity at which the other roller rotates.

4. The sheet folding apparatus according to claim 1, wherein the adjustment section is provided with a transport roller pair for overlapping the one-end side portion of the sheet and the folded portion folded in the first folding position to transport, and a drive section for driving the transport roller pair, and
the drive section halts one roller in the transport roller pair, and rotates the other roller in a transport direction.

5. The sheet folding apparatus according to claim 1, further comprising:
a fold-enhancing section adapted to nip the first folding position of the sheet folded in the folding section to perform fold-enhancing,
wherein the adjustment section adjusts a distance between the one end and the first folding position in the sheet with the first folding position subjected to fold-enhancing in the fold-enhancing section.

6. The sheet folding apparatus according to claim 1, wherein the adjustment section adjusts so that the one end of the sheet and the first folding position overlap each other.

7. A sheet folding apparatus for folding two portions of a first folding position of a sheet and a second folding position existing between one end of the sheet and the first folding position to perform Z-fold on the sheet, comprising:
a feed roller adapted to feed the sheet; and
a folding roller pair disposed downstream of the feed roller to fold the sheet in the first folding position and overlap a front-end side portion of the sheet in a feed direction and a folded portion folded in the first folding position to transport,
wherein the folding roller pair adjusts a distance between a sheet front end and the first folding position in a transport direction in the sheet with the front-end side portion and the folded portion overlapped with each other.

8. The sheet folding apparatus according to claim 7, wherein the folding roller decreases a distance between the front end of the folded sheet and the first folding position.

9. The sheet folding apparatus according to claim 7, wherein the folding roller pair shifts the front end portion of the sheet to adjust a position of the sheet front end with respect to the first folding position of the sheet.

10. The sheet folding apparatus according to claim 7, wherein one roller in the folding roller pair is rotated in a direction opposite to the transport direction to shift the front end portion of the sheet, and adjusts a position of the sheet front end with respect to the first folding position of the sheet.

11. The sheet folding apparatus according to claim 7, wherein a rotation velocity of one roller in the folding roller pair is lower than a rotation velocity of the other roller, and the distance between the sheet front end and the first folding position is adjusted, using a difference in shift velocity between the front end portion of the sheet and the folded portion of the sheet.

12. The sheet folding apparatus according claim 7, wherein one roller in the folding roller pair is halted, the other roller is rotated in the transport direction to shift the folded portion of the sheet, and the distance between the sheet front end and the first folding position is adjusted.

13. The sheet folding apparatus according to claim 7, further comprising:
a nip pressure changing section adapted to change nip pressure of the folding roller pair, wherein the nip pressure changing section decreases the nip pressure of the folding roller pair, in adjusting the distance between the sheet front end and the first folding position by the folding roller pair.

14. The sheet folding apparatus according to claim 7, further comprising:
a fold-enhancing section adapted to nip the first folding position of the sheet folded by the folding roller pair to perform fold-enhancing,
wherein after performing fold-enhancing on the first folding position in the fold-enhancing section, the folding roller pair adjusts the distance between the sheet front end portion and the first folding position.

15. The sheet folding apparatus according to claim 7, wherein the folding roller pair is driven to shift the sheet front end portion or the folded portion so that one end of the sheet and the first folding position are in an overlapping position.

16. A sheet folding apparatus for folding two portions of a first folding position of a sheet and a second folding position existing between one end of the sheet and the first folding position to perform Z-fold on the sheet, comprising:
a feed roller adapted to feed the sheet;
a folding roller pair provided downstream of the feed roller to overlap the first folding position with a front end portion to nip, in a state in which the front end portion of the sheet in a transport direction is nipped, to fold the first folding position of the sheet, nip a front-end side portion in a feed direction and a folded portion folded in the first folding position of overlapping sheet portions to transport, and fold the second folding position; and
a push member adapted to push the first folding position of the sheet to guide to a nip portion of the folding roller pair,
wherein after overlapping the first folding position with the front end portion to nip, the folding roller pair adjusts a distance between the front end and the first folding position of the sheet in a state in which the front-end side portion in the transport direction overlaps the folded portion folded in the first folding position.

17. The sheet folding apparatus according to claim 16, further comprising:
a fold-enhancing section disposed downstream of the folding roller to nip the first folding position of the sheet folded by the folding roller pair to perform fold-enhancing, wherein after performing fold-enhancing on the first folding position of the sheet in the fold-enhancing section, the folding roller pair adjusts the distance between the sheet front end portion and the first folding position.

18. The sheet folding apparatus according to claim 16, further comprising:
a nip pressure changing section adapted to change nip pressure of the folding roller pair, wherein the nip pressure changing section decreases the nip pressure of the folding roller pair, in adjusting the distance between the sheet front end and the first folding position by the folding roller pair.

19. The sheet folding apparatus according to claim 16, wherein before folding the second folding position, the folding roller pair adjusts the distance between the front end of the sheet and the first folding position.
